(19) United States
(12) Patent Application Publication
(10) Pub. No.: US 2023/0028517 A1
(43) Pub. Date: Jan. 26, 2023

(54) Reservation and Tracking System

(71) Applicant: Kweeber, Inc., Newport Beach, CA (US)

(72) Inventor: Marcialito V Nuestro, Newport Beach, CA (US)

(21) Appl. No.: 17/872,796

(22) Filed: Jul. 25, 2022

Related U.S. Application Data
(60) Provisional application No. 63/203,453, filed on Jul. 23, 2021.

(51) Int. Cl. G06Q 10/02; G06Q 50/12

(52) U.S. Cl. CPC G06Q 10/02; G06Q 50/12

(57) ABSTRACT

A reservation and tracking system has a central computer that enables a reservation by a customer, and tracking his or her location to determine if the reservation is going to be honored or needs to be cancelled or rescheduled. The reservation system program performs the steps of: sending a reservation reminder to the customer before the reservation; receiving either a confirmation or a cancellation of the reservation; updating the database to reflect either the confirmation or the cancellation; tracking, if authorized by the customer, the location of the customer, via the tracking system; determining if the customer is on track to arrive at the restaurant at the time of the reservation, and if not, contacting the customer to determine if they would like to cancel or reschedule the reservation; and updating the database to confirm the reservation when the customer arrives at the restaurant at the time of the reservation.

### CROSS-REFERENCE TO RELATED APPLICATIONS

This application for a utility patent claims the benefit of U.S. Provisional Application No. 63/203,453, filed Jul. 23, 2021.

### BACKGROUND OF THE INVENTION

### Field of the Invention

This invention relates generally to reservation and tracking systems, and more particularly to a reservation and tracking system for tracking customers who have reservations and automatically updating reservation information based upon the location of the customers.

### Description of Related Art

Typical reservations systems in restaurants enable a customer to reserve a table, at which time a table is set aside and is not available for use. If the customer having the reservation does not show up, this may result in a table going unused for a period of time. There is a need for an automated system that is able to update table reservation information to prevent this from happening. The present invention fulfills this long-felt need in the art, and provides further advantages as described in the following summary.

### SUMMARY OF THE INVENTION

The present invention teaches certain benefits in construction and use which give rise to the objectives described below.

The present invention provides a reservation and tracking system that enables reservation by a customer of one of a plurality of tables at a restaurant via a customer device, and tracking his or her location, to determine if the reservation is going to be honored or needs to be cancelled or rescheduled. The reservation and tracking system includes a central computer having a computer processor and a computer memory, the computer memory having a reservation system program, a tracking system, and a database, the reservation system program performing a process that comprises the steps of: receiving a reservation from the customer; sending a reservation reminder to the customer before the reservation; receiving either a confirmation or a cancellation of the reservation; updating the database to reflect either the confirmation or the cancellation; tracking, if authorized by the customer, the location of the customer, via the tracking system; determining if the customer is on track to arrive at the restaurant at the time of the reservation, and if not, contacting the customer to determine if they would like to cancel or reschedule the reservation; and updating the database to confirm the reservation when the customer arrives at the restaurant at the time of the reservation.

A primary objective of the present invention is to provide a reservation and tracking system having advantages not taught by the prior art.

Another objective is to provide a reservation and tracking system that tracks customers who have reserved a table, and updates the reservation and tracking system based upon the location of the customer.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a block diagram of a reservation and tracking system according to one embodiment of the present invention.

FIG. 2 is a flow diagram of a reservation process using a downloadable application of the system.

FIG. 3 illustrates a reservation screen generated by an application during the reservation process on a customer device, illustrating a reservation screen that includes a drawing of the restaurant.

FIG. 4 illustrates another embodiment of the reservation screen wherein the screen includes a photograph or computer generated 3D image of the restaurant.

FIG. 5 is a flow diagram of a tracking process of the reservation and tracking system.

FIG. 6 illustrates a screen of the reservation and tracking system viewed on a display in the restaurant.

### DETAILED DESCRIPTION OF THE INVENTION

The above-described drawing figures illustrate the invention, a reservation and tracking system that is adapted for making reservations and then tracking a customer and adapting the reservation according to the activity of the customer.

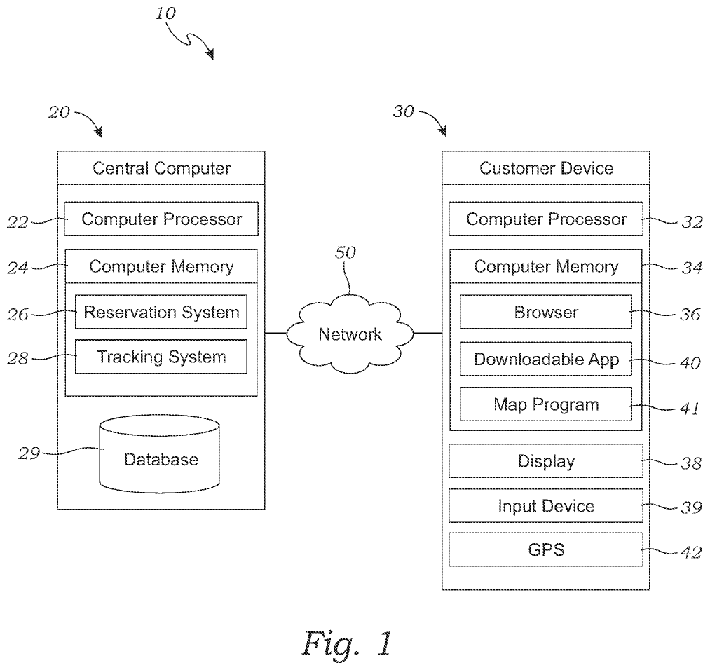

FIG. 1 is a block diagram of the reservation and tracking system 10 according to one embodiment of the present invention. As shown in FIG. 1, the reservation and tracking system 10 my include a central computer 20 for enabling reservations and tracking customers using a customer device 20 (e.g., smart phone, computer, laptop, tablet, or other similar device known in the art), as discussed in greater detail below.

As shown in FIG. 1, the central computer 20 includes a computer processor 22, and a computer memory 24. In the embodiment of FIG. 1, the computer memory 24 stores executable code that, when executed, enables the computer system to perform the processes described in greater detail below. In this embodiment, the computer memory 24 includes a reservation system program 26 operably installed thereupon, and may further include a tracking system 28. The function of the reservation system program 26 and the tracking system 28 are discussed in greater detail below. The central computer 20 may further include a database 29 for storing and updating data, also discussed in greater detail below.

The customer device 30 also comprises a computer processor 32, and a computer memory 34. In the embodiment of FIG. 1, the computer memory 34 stores executable code that, when executed, enables the computer system to perform the processes described in greater detail below. In this embodiment, the computer memory 34 includes a browser 36 and/or a downloadable app 40 for accessing the reservation system program 26. The downloadable app 40 may be a specialized software application which may be downloaded particularly for using this system, and the browser 36 may be a general purpose browsing program for accessing the software via a web page, or other technique known in the art. While two examples of suitable software are provided, any form of hardware and software known in the art may be utilized consistent with the teachings of the present invention.

In this embodiment, the customer device 30 may further include a display 38 (e.g., screen, monitor, or other form of display), an input device 39 (e.g., touch screen, keyboard, or other device well known in the art), a global positioning system (GPS) device 42, and other hardware and software known in the art. Since the hardware involved is well known in the art, it is not described in greater detail herein, but may include any arrangement known in the art for purposes of this invention.

For purposes of this application, the terms “central computer,” “customer device,” computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “customer” as used herein, refers to any individual, organization (e.g. corporation, LLC, and so on), or computer functioning on behalf of the individual or organization that desires to reserve a table or other facility at a place of business such as a restaurant.

The term “restaurant” as used herein, refers to any individual, organization (e.g. corporation, LLC, and so on), or computer functioning on behalf of the individual or organization that may be interested in providing, renting, or otherwise offering a seat, a table, and/or any other space or facility at a place of business such as a restaurant.

The term “table” is defined to include any table, seat (e.g., at a bar), cabana, section of tables, or other seating group that is reserved as a unit by a customer.

The central computer 20 interacts with a network 50, as discussed in greater detail below, such as via a network device in the form of communications hardware or software known in the art for enabling communications via a network. The network 50 may include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

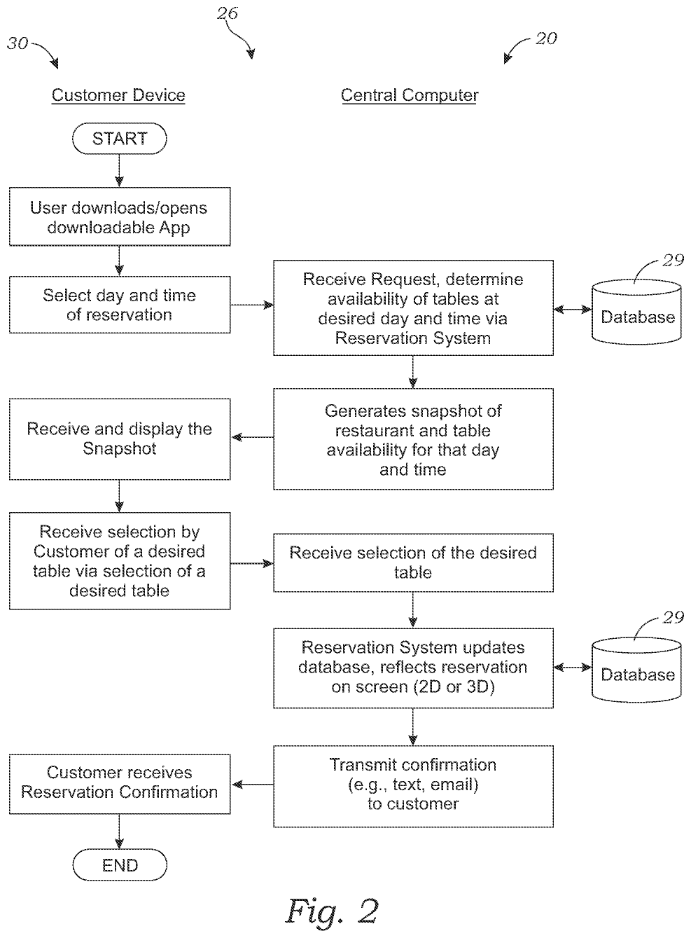

FIG. 2 is a flow diagram of a reservation process using the downloadable application 40 of the reservation and tracking system 10. A customer may first download and then log into the downloadable app 40, from the central computer 20, or an app store, or other computer mechanism known in the art. Alternatively, the browser 36 commonly already installed on the device 30 may be used to access, log into, and utilize the system 10. This software is accessed or opened using the customer device 30 of FIG. 1.

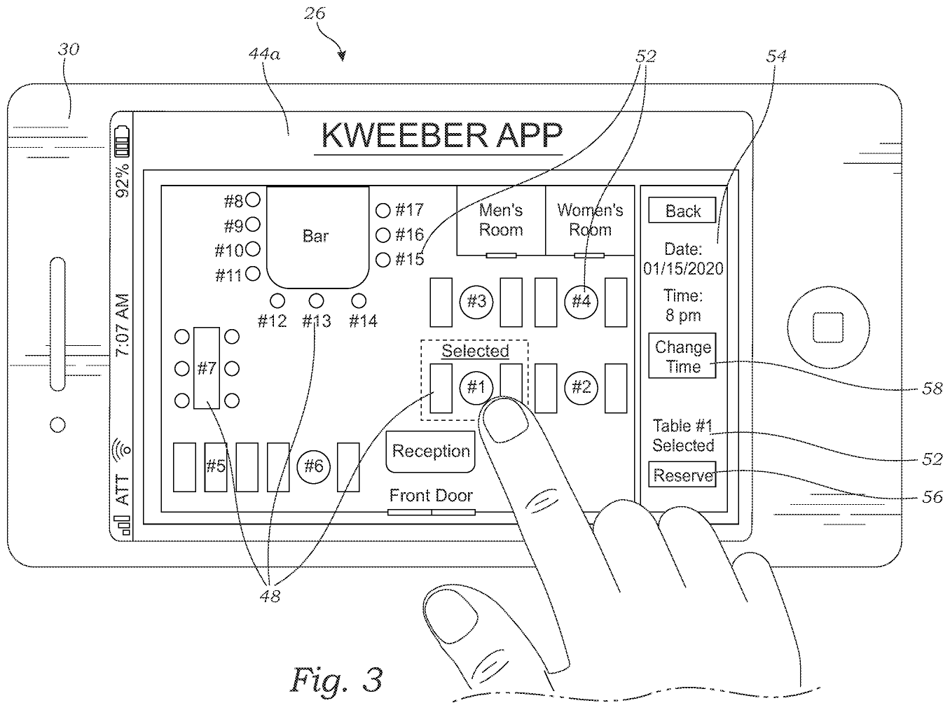

As shown in FIG. 2, the central computer 20 provides a request form 54 (one embodiment of which is shown in FIG. 3) from which the customer may select the day and time of a desired reservation for a restaurant (or similar commercial facility), and this request (along with any other desired data) may be sent via the network 50 to the central computer 20. Obviously, this request form 54 may be in any form known in the art for receiving a date and time for the reservation.

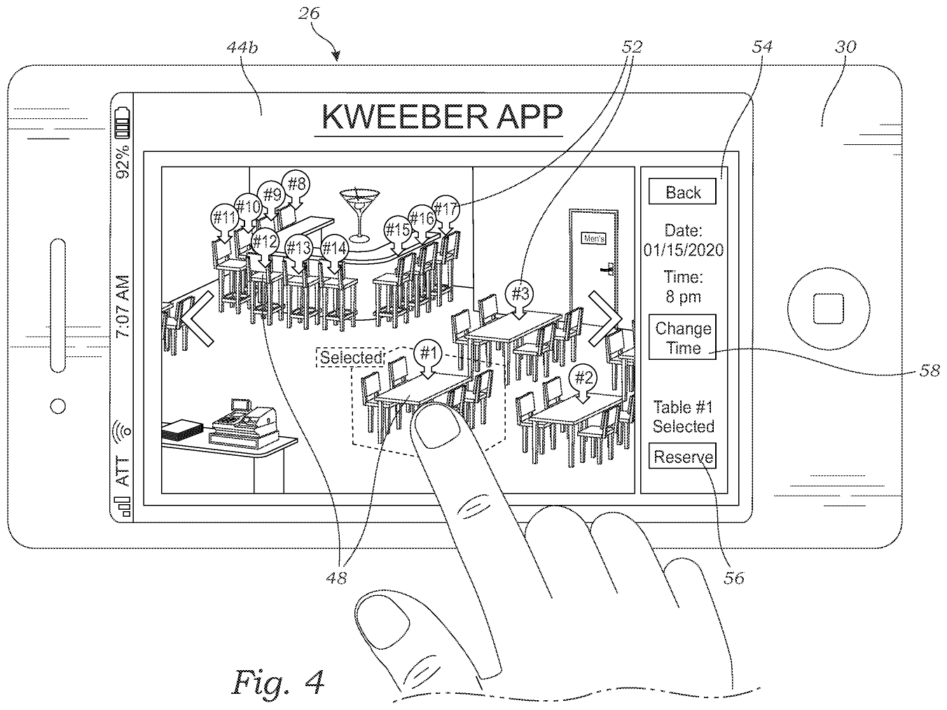

Once the central computer 20 receives the request form 54 filled out with the reservation request, it communicates with the database 29 to determine the availability of tables at the desired day and time, then generates a snapshot of table availability within the restaurant and sends it to the customer. The customer device 30 receives the snapshot and is able to select a desired table. Example snapshots of table availability are shown in FIGS. 3 and 4 and discussed below. Obviously, provisions may be made to select alternative days and times if a desired table is not available.

The central computer 20 receives the selection of the desired table and updates the database 29 to reflect the new reservation, which will be indicated on any newly generated snapshots. The central computer 20 transmits a confirmation (e.g., text, email, call, or any other method of notifying known in the art) to the customer of the reservation being made, which is received on the customer device 30. In some implementations of the reservation system 10, the customer may choose not to select a table, and be seated at any available table upon arrival at the restaurant.

In use, the application 40 may allow restaurant staff to disable the reservation feature, or select specific tables to be available at a given time, for online reservations, etc. The staff may have further capabilities using the application 40, e.g., manually setting a period of time that a reservation may be held before making the table available, or any other feature that is desirable to restauranteurs. In some embodiments, there may be further options for ordering from a menu prior to arrival at the restaurant, or for pick up, delivery, etc., which is well known in the art and should be considered compatible with the present invention. Furthermore, while the reservation and tracking system 10 is illustrated herein as being adapted to a restaurant and food-ordering context, the reservation system 10 may be used in other fields, e.g., to order groceries, clothing, etc., discussed in greater detail below.

FIG. 3 illustrates a reservation screen 44a generated by the application 40 during the reservation process on the customer device 30, in one embodiment of the invention. The screen 44a illustrated is an example based upon a drawing of a restaurant, or a similar graphic representation of the key components of the restaurant. The screen 44a may be stored or generated by the central computer 20 as discussed above. The reservation screen 44a may be viewed via the downloadable application 40 or by the web browser 35 (shown in FIG. 1), or any other system known in the art. As shown in FIG. 3, the screen 44a include a plurality of seating options 48 (e.g., a table) for the selected date and time. Each seating option 48 may include a designation 52 for the customer and restaurant staff to more easily reference. As illustrated in FIG. 3, the snapshot may include a region around each table that is associated with the illustrated table, so that tapping on the region using a touchscreen enables selection of the associated table.

The request form 54 may be provided on the reservation screen 44a, in the form of a sidebar (which may be located anywhere on the screen) having a reservation button 56 or equivalent for after the seating option 48 has been selected, as well as a button 58 to adjust the date and time. Once reserved, the seating option 48 may be restricted, locked, or indicated as “reserved” in some manner until the reservation has expired or been fulfilled. Staff may manually enter reservations, or otherwise restrict certain seating options, such as for private parties, or so that certain seating options cannot be reserved.

The reservation screen 44a of FIG. 3 is a plan view such that the customer may view the layout of the restaurant from above, and understand dimensions in scale using the 2-dimensional interface. This may be generated by the owner of the restaurant or anyone else assisting the owner. This drawing preferably includes any places or things of interest to the customers, such as restrooms, entrances, windows, etc., so that the customer is able to select the table that would best suit his or her needs (e.g., far or near a restroom, near or far from the entrance or bar, etc.).

FIG. 4 illustrates an alternative reservation screen 44b which is generated using a photograph of the restaurant. For purposes of this application, the term “photograph” is defined to include not only literal photographs, but also any form of equivalent 3D (virtual reality) image of the restaurant. The reservation screen 44b of FIG. 4 is an image from inside the restaurant, such that the customer may view the aesthetics and 3-dimensional space within the restaurant. In some embodiments, the reservation screen 44b of FIG. 4 is an interactive 360 degree image having applied logic so that the customer can virtually explore the space and select available seating options 48 by clicking on the image 44b. Other implementations may include further immersive experiences of the space, such as augmented reality, etc.

The reservation screens 44a and 44b illustrated in FIGS. 3 and 4 are merely exemplary embodiments, and those skilled in the art may devise many alternative screens, or include additional options (e.g., settings, profile, history, etc.) in the sidebar 54 or elsewhere within the application 40, as is well-known in the art. While one embodiment of such screens 44 are illustrated, the invention 10 should not be limited to this disclosure, but should be construed to include alternative embodiments which may be designed by one skilled in the art. For example, as mentioned above, in some embodiments the reservation system 10 is adapted to enable virtual shopping at a store such as a grocery store, boutique, etc. The customer would use the 2D and/or 3D interfaces to explore the store and select items they wish to reserve for purchase/viewing, or to order. The interfaces include a visual indication of which of the plurality of tables are available. For example, the colors of the tables may provide an indication (e.g., green tables are available, red are not), or any form of text, symbols, etc., may alternatively be used. Other uses may be implemented outside of a restaurant setting, as many fields may benefit from this particular implementation of a virtual reservation/shopping system.

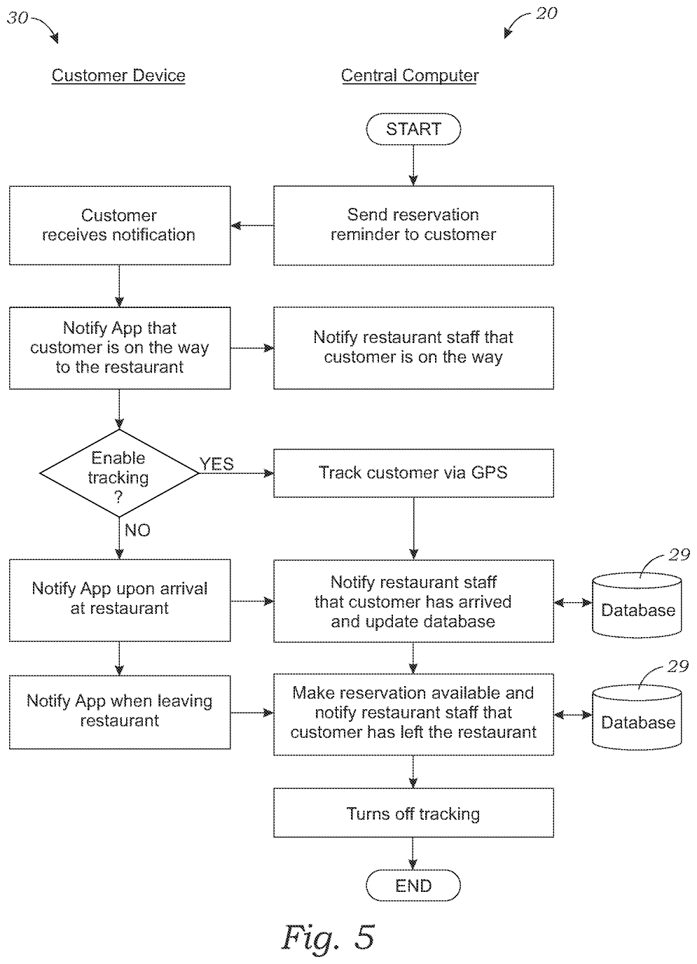

FIG. 5 is a flow diagram of a tracking process performed by the tracking system 28 (shown in FIG. 1) of the reservation and tracking system 10. As shown in FIG. 5, once a reservation has been made, the central computer 20 (of FIG. 1) may store the information in the database 29, and then send a reservation reminder to the customer immediately prior to the reservation time. For purposes of this application, “immediately prior” is defined to mean a suitable length of time prior to the reservation so that the customer will have time to arrive at the location in time (maybe around 1 hour, or 30 minutes, for example, although it could be other lengths of time deemed suitable). The length of time may be selected by one skilled in the art, and multiple reminders may be used, as determined by a skilled designer (e.g., a 1 hour reminder might be made, then another even closer to the actual reservation, such as 15 minutes). If the reservation is made far in advance, a reminder might be sent many hours in advance, or even a day in advance, depending upon what is deemed desirable by the customer.

The customer receives the reminder on the customer device 30 (e.g., as an alert from the app, a text message, an email, a notification from the downloadable app 40 (of FIG. 1), etc.), and enables the customer to transmit a response notice to the central computer 20, confirming the reservation and/or notifying the restaurant that he or she is on the way to the restaurant. The central computer 20 may notify the restaurant staff that the customer is on the way so they may perform any necessary preparations, or alternatively to cancel the reservation if the customer declines the reservation.

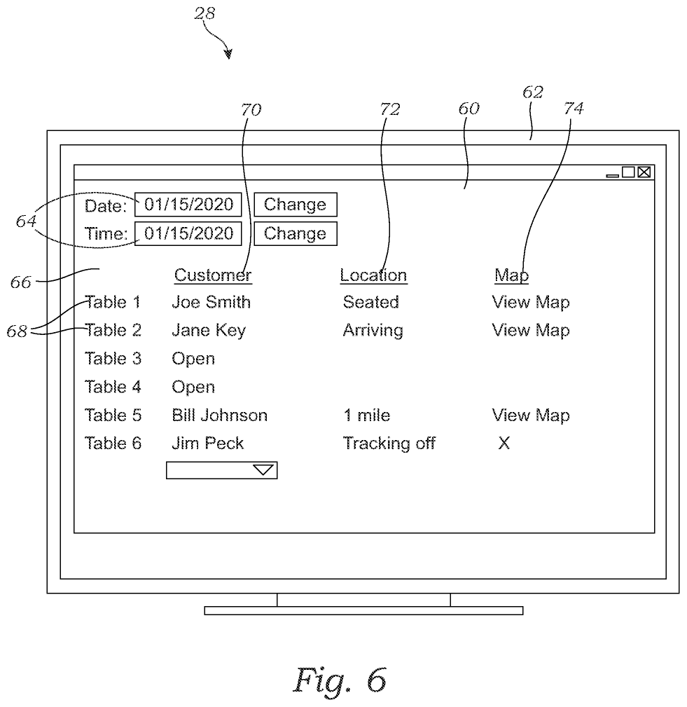

The customer may be given the option to enable tracking on their device via the GPS 42 (shown in FIG. 1). If authorized, the central computer 20 will track the customer device 30 on a map, which may be viewable by restaurant staff (as shown in FIG. 6). However, in some implementations, the restaurant server may have access only to the relative distance that the customer is from the restaurant (e.g., in miles, minutes, etc.), which provides the customer with more privacy than direct-location GPS tracking. In this embodiment, the software compares the map location of the customer, and the map location of the restaurant, and determines the distance (or time for travel), and reports this, while keeping the actual location of the customer confidential, thereby providing greater security for the customer, and potential liability protection for the system operators from hacking threats. In another embodiment, the customer could select which level of privacy he or she would like, i.e., an option where is actual location is reported, a middle option where only the distance/travel time is reported, or a confidential option where no information is provided.

Using tracking and geofencing technology, the movements of the customer may be tracked and analyzed, for purposes of determining whether the reservation is going to be honored. The program determines if the customer is on track to arrive at the restaurant at the time of the reservation, and if not, contacting the customer to determine if they would like to cancel or reschedule the reservation. For example, if the customer is far from the restaurant, and/or moving away, immediately prior to the reservation, follow up notices may be sent, and/or the reservation may be canceled or rescheduled.

When the customer arrives, the central computer 20 may notify restaurant staff and update the reservation database 29. The customer will be welcomed, seated, and the reservation honored and completed. If the customer has not enabled tracking, they may need to notify the restaurant staff of his or her arrival via the application, or in person, wherein the staff will manually update the reservation status.

When the customer leaves the restaurant, the customer or the restaurant staff may notify the application 40, or if tracking is enabled the application 40 will automatically recognize that the customer has left and the reservation is completed. The system may update the database 29, thereby making the table available again for use by another customer. Once the customer has left the restaurant, tracking may be turned off, thereby ending the tracking process.

FIG. 6 illustrates a screen 60 of the tracking system 28 viewed on a display 62 in the restaurant. The display 62 of FIG. 6 is operably connected to the central computer 20 having the reservation system 26 and the tracking system 28 that may communicate via the network 50 with the customer device 30.

As shown in FIG. 6, the screen 60 may include inputs 64 so that restaurant staff may view activity for a specific date and time. In this embodiment, the activity is illustrated via a graphic table 66 with columns such as seating option 68, customer name 70, and location of customer 72 and a map 74 which each may be selected to view if the customer enabled tracking.

The screen 60 illustrated in FIG. 6 is merely an exemplary embodiment, and those skilled in the art may devise many alternative screens, or include additional options (e.g., settings, profile, history, etc.) in a sidebar, button, etc., or elsewhere within the application 40, as is well-known in the art. While one embodiment of such a screen 60 is illustrated, the invention should not be limited to this disclosure, but should be construed to include alternative embodiments which may be designed by one skilled in the art.

While this embodiment of the invention is particularly directed towards making reservations at restaurants, those skilled in the art will understand that the teachings of this invention may be applied to any other similar situation in which reservations are made, and the restaurant is merely an exemplary embodiment. Furthermore, the title of the present application does not limit what may be claimed in the future, based upon and supported by the present application.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A reservation and tracking system that enables reservation by a customer of one of a plurality of tables at a restaurant via a customer device, and tracking his or her location, to determine if the reservation is going to be honored or needs to be cancelled or rescheduled, the reservation and tracking system comprising:
a central computer having a computer processor and a computer memory, the computer memory having a reservation system program, a tracking system, and a database, the reservation system program performing a process that comprises the steps of:
receiving a reservation from the customer;
sending a reservation reminder to the customer before the reservation;
receiving either a confirmation or a cancellation of the reservation;
updating the database to reflect either the confirmation or the cancellation;
tracking, if authorized by the customer, the location of the customer, via the tracking system;
determining if the customer is on track to arrive at the restaurant at the time of the reservation, and if not, contacting the customer to determine if they would like to cancel or reschedule the reservation; and
updating the database to confirm the reservation when the customer arrives at the restaurant at the time of the reservation.

2. The reservation and tracking system of claim 1, wherein the central computer performs the additional step of cancelling the reservation and making the table available once the customer has left the restaurant.

3. The reservation and tracking system of claim 1, wherein the tracking system generates a screen that includes a customer name and a location of the customer.

4. The reservation and tracking system of claim 3, wherein the screen generated by the tracking system enables access of a map that shows the location of the customer.
